(19) United States
(12) Patent Application Publication
(10) Pub. No.: US 2012/0251664 A1
(43) Pub. Date: Oct. 4, 2012

(54) FRESH DAIRY PRODUCTS WITH SATIETOGENIC POWER AND METHODS FOR PREPARING SAME

(75) Inventors: Pierre AYMARD, Antony (FR); Anne LLUCH, Palaiseau (FR); Véronique ARNOULT DELEST, Antony (FR); Laurent SCHMITT, Igny (FR); Antonio SANCHEZ HEREDERO, Barcelona (ES); Jose-Enrique SOLER BADOSA, Barcelona (ES); Deanna CARLSEN, Forth Worth, TX (US); Gilles LEBAS, Paris (FR); Arnaud Lyothier, Asnieres (FR); Benoît BERTHET, Palaiseau (FR); Fabienne DELOFFRE, Paris (FR)

(73) Assignee: Compagnie Gervais Danone

(21) Appl. No.: 13/525,204

(22) Filed: Jun. 15, 2012

Related U.S. Application Data
(62) Division of application No. 11/917,640, filed on Dec. 14, 2007.

(30) Foreign Application Priority Data
Jun. 17, 2005 (FR) 0506192

(51) Int. Cl. A23C 9/12; A23C 9/154; A23C 9/152; A23C 9/123; A23C 19/00

(52) U.S. Cl. 426/36; 426/34; 426/43

(57) ABSTRACT

The invention concerns a fresh dairy product with low fat and sugar content and low energy density, comprising one or several satietogenic ingredients, as well as a method for making such a product. Said satietogenic ingredient(s) comprise proteins, in particular milk proteins and preferably serum milk proteins, associated with water-soluble dietary fibers and preferably viscosifying water-soluble dietary fibers.

The present invention relates to a fresh dairy product low in fats and sugars, with low energy density, comprising one or more satietogenic ingredients, as well as a manufacturing process for such a product. Said ingredients comprise proteins, especially milk proteins and preferably seric milk proteins, where required, associated with hydrosoluble dietary fibre and preferably viscosifying hydrosoluble dietary fibre.

The increase in the incidence of obesity and its complications is at such a level today that the World Health Organisation, in its report “Diet, nutrition and the prevention of chronic diseases” of March 2004, estimates that this is an epidemic evolution. Its social and economic cost makes an urgent case for employing actions supported not only by consumer education and establishing communication rules but also nutritional improvement in manufactured products.

Although the causes identified are multiple (food excessively rich in energy, sedentary lifestyle or lack of physical activity, influence of television and publicity . . . ), the food industry is frequently incriminated. Deserving of reproach especially are dairy factories for supplying consumers with products having an excess of fat, sugar, too salty, and above all too tasty, resulting in difficulty for consumers to effectively regulate their food intake.

The initial issue of managing weight is the balance between energy intake and expenditure. Effective means for regulating contributions therefore consists of controlling food intake. To this effect, the scientific literature today announces proof attesting that due to their nutrient content certain foodstuffs can play a more or less favourable role on satiety and, therefore, on control of food intake.

In this context, there is a real demand by consumers for products designed to help them manage their weight, especially with better control of the sensations of hunger (for example causing a slowdown in the occurrence of the sensation of hunger between two meals). Typically, such products are addressed to those consumers who care about their figure, who generally make an effort, or would like to, to reduce their food intake, but who suffer especially from the more or less recurrent and tenacious occurrence of sensations of hunger in the case of diets, these sensations more often than not being responsible for diets failing.

Satiety is defined by the absence of hunger signals, which, when present, incite the desire to consume food. After a meal or food intake, the ingested food causes progressive reduction of the state hunger to finally lead to a total stop in food intake. This effect is mediated by a complex process, first involving sensorial then cognitive effects, then pre-absorptive and finally post-absorptive effects from the food. The whole of this process is described in the cascade of satiety proposed by J E Bundell (Green et al, 1997).

The state of satiety results in fact from metabolic conditions in which the cells of the organism (and particularly certain cells of the hypothalamus) continue to have the capacity to oxidise glucose available in an adequate quantity to satisfy their metabolic needs. This principle is the foundation of the “glucostatic theory of the control of the food intake”, formulated since 1953 by Jean Mayer who proposed the hypothesis according to which “the short-term articulation between energy needs and energy intake was under glucostatic control”. Since then, numerous complementary scientific arguments have reinforced the validity of this hypothesis (Louis-Sylvestre & Le Magnen, 1980; Melanson et al, 1999), and even if other theories are likewise proposed.

According to the above hypothesis, hunger therefore results from the drop in intracellular availability of glucose. However, given the intestinal absorption period of nutrients, in particular of glucose, the halt in ingestion cannot be directly related to nutrients consumed throughout a meal. It must therefore also employ distinct physiological mechanisms qualified as “mechanisms of satisfying”. Satisfying determines the quantity of foodstuffs (or energy) consumed during the meal, a quantity which is unconsciously evaluated by the brain of the subject due to all the oral, gastric and intestinal stimulations associated with ingestion and resulting therefrom (Booth, 1985).

If there is an interest in the factors capable of modulating satiety, it should be remembered that the duration of the state of satiety depends on the use of available glucose, which in turn depends on the use of other nutrients. This is how the composition of macronutrients of food ingested and/or their physical-chemical properties is likely to influence the speed of digestive absorption, and the metabolic use of these foodstuffs. These characteristics of the ingested product therefore constitute as many factors likely to modify the duration of satiety induced thereby.

Of the methods for measuring satisfying and satiety, methods for measuring behavioural markers on the one hand, and methods for measuring peripheral markers on the other hand are generally distinguished. In addition, methods for measuring central markers have also been reported. Table 1 hereinbelow lists the most current markers. For more information on these markers, see the review by De Graaf et al, 2004.

TABLE 1

| | Satisfaction | Satiety |
|---|---|---|
| Markers | (end of meal) | (start of meal) |
| Compartmental | Food intake | Previous food |
| | | intake |
| | | Time lapse between |
| | | meals |
| | Determination of | Determination of |
| | subjective appetite | subjective appetite |
| | (e.g. hunger and | (e.g. hunger and |
| | stomach fullness | stomach fullness |
| | feeling) | feeling) |
| Peripheral | Stomach distension | Evolution of |
| | | plasmatic rate of |
| | | glucose in blood |
| | | (ST) |
| | Measuring plasmatic | Measuring plasmatic |
| | CCK | leptine (LT) |
| | (cholescystokinine) | |
| | Measuring plasmatic | Measuring plasmatic |
| | GLP-1 (glucagon- | ghreline (ST & LT) |
| | like peptide-1) | |
| Central | Image of brain | Image of brain |

ST: short-term
LT: long-term

The literature reports a certain amount of research done on humans with foodstuffs having variable protein, glucide and lipid contents. These studies measured the relative satietogenic effect of these diverse macronutrients (Poppitt et al, 1998; Westererp-Plantega et al, 1999; Araya et al, 2000; Warwick et al, 2000). According to the conclusions of these works,
proteins have the most important effect on satiety and satisfying;
lipid content of the food does not seem to have any significant effect on satiety;
glucide content exerts a moderate effect both on satiety and on satisfying.

It is important to emphasise that all work completed to date does not however draw very precise conclusions, in particular as to the specific effects of such or such proteins, the different types of fatty acids or even glucides (for example as a function of their glycaemic index). In particular, work conducted in 1999 on animals has shown the superiority of proteins over glucides, but the nature of proteins (milk proteins, compared to gluten) had no effect (Bensaid et al, 2002). Neither does the literature define the precise contents of these nutrients to be attained in foodstuffs to obtain the desired effect. A review published in April 2004 (Anderson & Moore, 2004) confirms the role of proteins in the regulation of food intake in humans, especially due to their effects on satiety.

With respect to the potential effect of dietary fibre, different works (Delargy et al, 1997; Burton-Freeman, 2000; HoIt et al, 2001; Howarth et al, 2001) agree that the content and the nature of fibres in food combine to boost its satisfying and satietogenic character, principally by two way of mechanisms:
the increase in time for mastication and gastric distension, above all for insoluble fibres; and
the slowing of time for gastric emptying and intestinal absorption of nutrients, above all for viscosifying hydrosoluble fibres.

In particular, of the numerous dietary fibre studied by the inventors within the scope of the present invention, guar gum constituted a particularly engrossing investigation track. The majority of works reported in the prior art actually shows that a dose of approximately 2 g of guar gum per intake of food product helps modulate the subjective sensations of satiety in an individual consuming this product. It is important to point out that to date the notion of “dietary fibre” is defined differently in different countries. So, in the United Kingdom, the Committee on Medical Aspects of Foods, COMA gave a highly restrictive definition in 1998: “Dietary fiber is non-starch polysaccharide as measured by the Englyst method”. The Englyst method, acknowledged as a reference method in the United Kingdom by the UK Food Standard Agency, doses as dietary fibre all non-amylaced polysaccharides, with the exclusion of fructo-oligosaccharides and non-glucidic compounds (lignins, tannins, . . . ). In the rest of Europe, the reference method is AOAC 985.29 (AOAC: Association of Analytical Communities) which acknowledges as dietary fibre polysaccharides and non-glucidic compounds as well as the insoluble fraction of fructo-oligosaccharides. A wider still definition of dietary fibre is provided by the American Association of Cereal Chemists, AACC1 2000: “dietary fibre are an edible part of vegetable origin or analog glucides neither digested nor absorbed in the small intestine and partially or completely fermented in the colon. The fibres include polysaccharides, oligosaccharides, lignin and other vegetable substances”.

It is therefore specified that for the purposes of the present invention dietary fibre respond to the broad definition of all compounds which can be dosed as fibres by an appropriate method (total fibres by the AOAC 985.29 method, fructo-oligosaccharides by the AOAC 997.08 method). Such fibres are:
reserve polysaccharides such as glucomannanes extracted from konjac grains, galactomannanes originating from grains of guar, carob, karaya, tracaganth and fenugreek;
structure polysaccharides (present in vegetable walls) such as pectins, alginates, carrageenans;
   polysaccharides produced by bacterial fermentation, such as xanthan, gellane, . . . ;
vegetable exudates (acacia gum, larch extracts);
   oligofructoses or fructooligosaccharides extracted from chicory;
synthetic polymers such as polydextrose.

The fibres used in the present invention are recognised as fibres by the three definitions.

Since then, in the light of information available to date in the literature, proteins and/or the dietary fibre therefore seem to have a notable interest for formulating a food product with satietogenic power.

It is evident that apart from the nutritional composition of foodstuffs, their physical-chemical characteristics likewise have an impact on their satietogenic and satisfying properties.

Thus, the energy density of foodstuffs seems to be an unfavourable factor according to a recent study showing the more the content of lipids (therefore calories) grew, the more important the energetic ratio of the subjects was (Green et al, 2000). However, according to the majority of studies, it remains difficult to conclude on the specific effect of the caloric density because, when it varies, the volume consumed varies likewise (Beil et al, 1998; Araya et al, 1999). This is confirmed by different works by B. RoIIs (Rolls et al, 1999; 2000) showing that modification of the preloading volume due to air or water significantly reduced hunger and energy consumed at the following meal.

The effect of the texture of combined foodstuffs has not been studied much. In the review by Howarth et al (2001), it is reported that the increase in mastication time and accordingly the increase in salivary secretions (for example with fibres) could have a favourable impact on satisfying. Also, differences in texture can also have metabolic consequences, for example at the level of insulin secretion (Laboure et al, 2002).

In addition, apart from the texture, the effect of viscosity of foodstuffs is also an important factor. The works of Marciani et al (2001) and Mattes et al (2001) have shown that high viscosity first favoured good satisfying (probably by volume effect) and, then, good satiety (probably by effect on the gastric emptying).

Since then, for the purpose of developing a satietogenic dairy product, the inventors sought to multiply the effects by trying to associate enrichment in proteins and/or dietary fibre with modifications in texture and an increase in viscosity. In fact, these different elements, combined with one another, would be advantageous in favouring the occurrence of satiety. All the same, such associations impose technological constraints difficult reconcile in practice, thus explaining the global absence on the current market of satietogenic products, especially in the range of fresh dairy products satisfactorily combining all or part of these effects.

There is thus a need for food products, especially fresh dairy products, low in fats and sugars, low in calories, imbued with satietogenic power, and whereof the organoleptic characteristics are satisfying for the consumer and compatible with production processes of fresh standard dairy products.

In the context of the invention, “fresh dairy products” more particularly designate fresh and fermented dairy products, ready for human consumption, that is fresh and fermented dairy foodstuffs. The present application more particularly targets fermented milks and yoghurts. Said fresh and fermented dairy foodstuffs can alternatively be white cheeses or petits-suisses.

The terms “fermented milks” and “yoghurts” are given their usual meanings in the field of the dairy industry, that is, products destined for human consumption and originating from acidifying lactic fermentation of a milk substrate. These products can contain secondary ingredients such as fruits, vegetables, sugar, etc. Reference can be made, for example, to French Decree No. 88-1203 of 30 December 1988 relative to fermented milks and yaourt or yoghurt, published in the Official Journal of the French Republic of 31 December 1988.

Reference can likewise be made to the “Codex Alimentarius” (prepared by the Commission of the Codex Alimentarius under the aegis of the FAO and the OMS, and published by the Information Division of the FAO, available online at http://www.codexalimentarius.net; cf. more particularly volume 12 of the Codex Alimentarius “Codex standards for milk and dairy products”, and the standard “CODEX STAN A −1 1(a)-1975”).

The expression “fermented milk” is thus reserved in the present application for a dairy product prepared with a milk substrate which has undergone treatment at least equivalent to pasteurisation, seeded with microorganisms belonging to the characteristic species or species of each product. “Fermented milk” has not undergone any treatment which might subtract from an element making up the milk substrate used and especially has not undergone draining of the coagulum. Coagulation of “fermented milks” must not be obtained by means other than those resulting from the activity of microorganisms used.

The term “yoghurt” is reserved for fermented milk obtained, according to local and constant usage, by the development of specific thermophilic lactic bacteria known as Lactobacillus bulgacus and Streptococcus thermophilus, which must be in the living state in the finished product, at the rate of at least 10 million bacteria per gram relative to the lactic part.

In certain countries, regulations require the addition of other lactic bacteria to the production of yoghurt, and especially the additional use of strains of Bifidobacterium and/or Lactobacillus acidophilus and/or Lactobacillus casei. These additional lactic strains are intended to impart various properties to the finished product, such as that of favouring equilibrium of intestinal flora or modulating the immune system.

In practice, the expression “fermented milk” is therefore generally utilised to designate fermented milks other than yoghurts. It can also, according to country, be known by names as diverse as, for example, “Kefir”, “Kumtss”, “Lassi”, “Dahi”, “Leben”, “Filmjolk”, “Villi”, “Acidophilus milk”.

With respect to fermented milks, the quantity of free lactic acid contained in the fermented milk substrate must not be less than 0.6 g per 100 g at point of sale, and the protein content in the lactic part must not be less than that of normal milk.

Finally, the name “white cheese” or “petit-suisse” is, in the present application, reserved for unrefined non-salty cheese, which has undergone fermentation by lactic bacteria only (and no fermentation other than lactic fermentation).

The content of dry matter of white cheese can be lowered to 15 g or 10 g per 100 g of white cheese, according to which their fat content is more than 20 g, or at most equal to 20 g per 100 g of white cheese, after complete desiccation. The content of dry matter of white cheese is between 13 and 20%. The content of dry matter of a petit-suisse is not less than 23 g per 100 g of petit-suisse. It is generally between 25 and 30%.

Here, “standard manufacturing process” is understood to be a process employing essentially simple and/or conventional steps and equipment. Preferably, a process called “standard” responds to requisites generally found in the food industry and, more particularly, in the dairy industry, specifically: (i) satisfactory overall cost management; (ii) fairly brief manufacturing times of products (notion of yield); (iii) “delayed differentiation” consisting of using for as long as possible the same production chain for final products having different characteristics (contents of ingredients, types of ingredients, . . . ), especially starting out from the same white mass in which one or more intermediary preparations are incorporated containing ingredients more specific to the final product later during the process; (iv) in relation to “delayed differentiation”, absence of contamination of production chains by particular ingredients as long as possible during the manufacturing process, contamination otherwise requiring the need to proceed with intricate cleaning steps and for long times which generally delay obtaining the finished product; (v) absence of microbiological contamination of products at different steps of the process; (vi) fairly long storage time of intermediary and final products; and (vii) “conviviality” for the manufacturer handling the products, that is, for example concerning fresh dairy products these must be injectable and/or pumpable, at the same time also being “convivial” for the consumer (products must exhibit the expected unctuousness and spooning capacity if they are yoghurts or fresh cheese; or be sufficiently unctuous while remaining liquid if drinkable yoghurts).

All these constraints, more or less irreconcilable in practice, have been studied by the inventors who succeeded, not without many difficulties and in an unhoped-for manner, in finalising means, especially products and processes, which respond quite satisfactorily to current needs.

The present invention therefore concerns a fresh dairy product low in fats and sugars, with low energy density, having an enrichment factor in satietogenic proteins varying from 2 to 5 approximately, preferably varying from 3 to 5 approximately, with a preferred value at 3 approximately, relative to the content of proteins in the initial product. The product thus enriched with satietogenic proteins is supplied with satietogenic power.

The term “satietogenic” such as used here responds to the definitions commonly held in the field. This notion also forms the object of a growing number of publications. By way of convenience, it is specified that “satietogenic product or ingredient” is understood here to mean a product or an ingredient which, for the consumer, especially causes a decreases in the sensations of hunger, a drop in appetite, an increase in stomach fullness, a delay in the return of hunger between two food intakes, prolongation of the interval between two food intakes, a decrease in dietary allowances after ingestion. These different effects can be observed in isolation or in combination, in all or in part. It is also recalled that there are methods for measuring markers which determine the satietogenic power of an ingredient or product, as described above (see especially Table 1 above). In particular, satietogenic ingredients such as proteins contribute to the liberation of pre- and post-absorptive signals which participate in the control of gastric kinetics, pancreatic secretion and dietary allowances. The actions of these signals act peripherally and centrally (see Table 1 above).

More particularly, said satietogenic ingredients are used in the product so as to retard its metabolisation. Here, “slowing of metabolisation” of a product is defined as being slowing and/or delay in digestion and/or absorption and/or assimilation of said product.

In terms of the invention, a product is “low in fats” if it contains:

less than 3 g approximately of fats per 100 g of product when the product is solid (of farm yoghurt or fresh cheese type);
less than 1.5 g approximately of fats per 100 ml of product when liquid (of drinkable yoghurt type).

In this respect, the Applicant specifies that the definition hereinabove conforms to the directives of the Codex for the use of nutritional claims (Codex Guidelines for the Use of Nutrition Claims) adopted by the Commission Codex Alimentarius in 1997 and modified in 2001.

A product “low in sugars” or “with low sugar content” is such that it contains no more than:

0.5 g of sugars approximately per 100 g of product if solid;
2.5 g of sugars approximately per 100 ml if liquid.

Here too, the applicant points out that this definition conforms with the Opinion of the Interministerial Commission for the study of products destined for particular feed, dated 8 July 1998 and relative to the non-deceptive character of the thresholds of nutritional claims.

Product “with low energy density” is understood here to mean a product contributing from 40 to 120 kcal approximately per 100 g, preferably from 60 to 110 kcal approximately per 100 g, preferably still from 70 to 100 kcal approximately per 100 g.

The expression “enrichment factor of the product in (or with) satietogenic proteins varying from 2 to 5 approximately relative to the content of proteins in the initial product” means that satietogenic proteins were added at a rate of approximately 2 to 5 times the quantity of proteins contained in the initial product.

In terms of the invention, an “initial product” is a fresh dairy product placed in the average of the products of its category in terms of protein content. Therefore, typically, an initial product of the yoghurt category will contain on average 4.15% of proteins approximately. An initial product of the drinkable yoghurt category and that of fresh cheese will contain respectively on average 2.74% and 6.16% of protein approximately.

For example, ingestion of the product according to the invention will cause for the consumer an increase in the protein content of his daily food intake by at least 17 to 35 g approximately, preferably at least 30 to 35 g approximately, in the case of daily intake of 2 portions of 125 g each (proposed daily quantity) of a product of yoghurt or white cheese type whereof the content of total protein varies from 7 to 13% approximately.

The “total protein content” or the “proteic rate” of a product corresponds to the sum, expressed as a percentage, of the concentration of the product in casein and seric protein. Typically, the skim milk generally utilised by industries contains 3.3% of protein approximately.

Furthermore, it is evident that the majority of proteic milk ingredients contribute lactose. For reasons of technical feasibility where lactose is likely to alter or inhibit fermentation, priority will be given to proteic ingredients such as the fresh dairy product according to the invention contains no more than 11 g approximately of lactose per 100 g. Therefore, of the most appropriate proteic ingredients within the scope of the present invention,

the ingredient “sodium caseinate” has the advantage of contributing texturising proteins without lactose. This ingredient is constituted on average by 92% of protein approximately;

the “skim milk powder” ingredient (or PLE) is the classic ingredient for contributing proteins. This ingredient has the advantage of being inexpensive, but the disadvantage of contributing much lactose (approximate composition: 50% of lactose, approximately ⅓ of milk protein (caseins and seric proteins) and the rest in mineral salts and others);

particulate seric proteins produce good organolepsy. By way of example, the ingredient cited in the examples hereinafter (Simplesse 100 E) contains approximately 50% of protein.

In general, it is evident that using satietogenic ingredients, singly or in association, posed technical difficulties in particular for the inventors, difficult to reconcile and resolve, at the following different levels:

1—flow capacity of the product (important for manufacturer and consumer): this relates to what was described earlier under the term “conviviality”;

2—the homogeneity of consistency of the product, reflecting the overall physical quality of the finished product: absence of coagulated, precipitated, aggregated ingredients (for example with respect to proteins tending to coagulate in acid medium and/or to hot denature, eventually forming aggregates); good dispersion of the various ingredients (for example when fibres are used as powders);

3—the organoleptic properties of the finished product, important for the consumer: texture, craving and good taste (absence of “parasitic” tastes such as bitterness, excessive acidity, a sharpness which can be observed for example in certain ingredients under certain conditions).

The inventors therefore needed to make the objectives associated with the organoleptic and nutritional properties of the product compatible (satietogenic power, low energy density, good taste, craving and texture) with the constraints of production (technological feasibility of the product, aptitude for fabrication with respect to requirements (i) to (vii) mentioned above). In the present context this is why only the fresh dairy products satisfactorily fulfilling all the criteria mentioned hereinabove (from (i) to (vii) and from 1 to 3) are considered to be covered by the terms “fresh dairy products”, utilised especially in the claims following. The research efforts of the inventors enabled them to disclose that only the combination of characteristics of the present invention fulfils all these criteria satisfactorily.

The satietogenic proteins used for enriching the product according to the present invention comprise milk and/or vegetable proteins. The milk proteins are, for example, selected from milk powder, caseins and seric proteins. Vegetable proteins include, for example, soya proteins.

Preferably, the fresh dairy product according to the invention comprises seric satietogenic milk proteins. Seric proteins are small stable proteins in acid medium but sensitive to thermal treatment. Of the seric satietogenic proteins utilisable within the scope of the invention preference is for those particulate seric proteins whereof the effect is to considerably improve the organoleptic properties of the product (the proteins of the trade mark SIMPLESSE sold by CP Kelco—Atlanta, Ga., USA are utilised, for example). These particulate seric proteins have a diameter of approximately 1 μm, allowing them to mime fat globules in a preparation or product.

According to a particularly preferred embodiment, the inventive fresh dairy product has not only the enrichment factor in satietogenic proteins mentioned hereinabove, but also an enrichment factor in seric satietogenic proteins varying from 2 to 5 approximately, preferably varying from 3 to 5 approximately, with a preferred value at 3 approximately, relative to the content of seric proteins in the initial product.

Advantageously, particulate seric proteins represent from 2 to 30% by weight approximately, preferably from 8 to 25% by weight approximately and, even more preferably, at least 16% by weight approximately, of the satietogenic proteins incorporated into the fresh dairy product according to the present invention.

According to an embodiment, the fresh dairy product according to the present invention further comprises at least one additional ingredient satietogenic selected from vegetable proteins and preferably soya proteins, milk powder, caseins, hydrosoluble dietary fibre and preferably viscosifying hydrosoluble dietary fibre, and their mixtures.

According to an embodiment, the fresh dairy product according to the present invention is selected from yoghurts, drinkable yoghurts, fresh cheeses, fermented milks.

Advantageously, the content of total proteins in said product varies from:

5 to 20% approximately for yoghurt;
3 to 20% approximately for drinkable yoghurt;
6 to 20% approximately for fresh cheese; with more beneficial values:
6 to 15% approximately for yoghurt;
4 to 15% approximately for drinkable yoghurt;
7 to 15% approximately for fresh cheese; and preferred values:
6 to 7% approximately for yoghurt;
4 to 5% approximately for drinkable yoghurt;
7 to 8% approximately for fresh cheese; and more preferred values:
6.5% approximately for yoghurt;
4.7% approximately for drinkable yoghurt;
7.5% approximately for fresh cheese.

According to an embodiment, the product further comprises one or more pectins. More particularly, the product according to the invention can contain at least one pectin having the property of interacting with seric proteins in acid medium so as to prevent or limit their aggregation during thermal treatment of the preparation. Such a pectin is for example highly methylated. When the pH of the intermediary preparation is less than the pHi of the proteins, they are charged positively and can create attractive electrostatic interactions with negatively charged pectin chains.

According to another embodiment, the inventive product further comprises dietary fibre other than pectins. Examples of these fibres are non-hydrosoluble fibres of fruits and cereals, resistant starches and resistant maltodextrins, polydextrose, fructooligosaccharides (FOS), and their mixtures. Hydrosoluble fibres satietogenic, which are preferably viscosifying, can also advantageously be cited. Such fibres can especially be selected from galactomannanes and especially guar gum, glucomannanes, carrageenans, alginates, psyllium, and combinations of these.

Viscosifying fibres are usually qualified as fibres which contribute low-dose viscosity. The term “fibre” makes reference to non-metabolised (or only very partially) compounds such as defined above. Of these compounds, polymers of high molar mass are called “viscosifying”, to the extent their incorporation in low doses (typically between 0.05 and 0.5% approximately) can boost viscosity of the solvent by several orders of magnitude. This effect is linked to considerable osmotic swelling of the polymer chain in the solvent, which adopts a (more or less) extended conformation, mobilising a large number of water molecules. In fact, the solution containing the viscosifying (or thickening) polymer flows more slowly, the viscosity being defined as the ratio between the constraint exerted to generate flow and the characteristic speed of this flow. To objectively quantify the thickening character of a polymer, it is advantageous to refer to the volume occupied by the polymer chain in solution: the intrinsic viscosity is by definition the volume known as “hydrodynamic” occupied per gram of polymer in solution. Typically, native guars have an intrinsic viscosity of the order of 10 dl/g, whereas partially hydrolysed guars mentioned in the present invention have intrinsic viscosities between 0.3 (Sunfiber®) and 1.0 dl/g (Meyprodor 5) approximately. The contribution of viscosity by the polymer can be characterised by the concentration incorporated product (in g/dl) by the intrinsic viscosity (in dl/g). This adimensional number means that viscosity is linked at the same time to the hydrodynamic volume of the polymer in solution and to the concentration used. The pertinence of this invariant for describing the thickening effect has been pointed out by numerous teams working on the rheology of biopolymer solutions (Robinson et al, 1982, Launay et al., 1986).

The numerous assays conducted by the inventors showed that native guar, highly viscous, can be incorporated only in low doses into the intermediary preparation, that is, in doses not exceeding 1%. In fact, the texture of the preparation is viscous, viscoelastic, incompatible with a standard manufacturing process (see definition above), and does not suit the consumer, who does not find the texture “short” characteristic des products of yoghurt, cheese or drinkable yoghurt type. Inversely, partially hydrolysed guar has a lower intrinsic viscosity but can be incorporated up to 20% in an intermediary preparation. Finally, the [concentration×intrinsic viscosity] products are comparable, since this product is approximately 10 for native guar and is between 6 and 20 for partially hydrolysed guars mentioned in the present invention. If it is considered that the incorporated quantities are high, these can therefore be soluble viscosifying fibres, even with a partially hydrolysed polymer.

The dietary fibre contained in the milk product of the invention preferably comprise at least guar gum, polysaccharide with high molar mass extracted from the shrub Cyamopsis tetragonoloba L. by milling processes. This natural galactomannane is a compound of mannose units (D-mannopyranose) linked in β(1-4) and statistically carrying at position α(1-6) a galactose unit (D-galactopyranose) per 2 units mannose.

According to an embodiment said guar gum is at least partially hydrolysed.

Here, “partially hydrolysed” means that the mass (or size) of the chains is intermediate between that of the native guar and that of sugar residues which make up the guar. The average molar mass of the native guar (Mw) is of the order of approximately 10⁶ g/mol, with more or less wide distribution linked to biological variability and the extraction process. The molecular mass of the galactose or mannose monomer is 180 g/mol. The partially hydrolysed guar gums mentioned in the invention have molar masses Mw (measured by steric exclusion chromatography coupled with refractometry and diffusion of light) between 5000 and 100,000 g/mol approximately, preferably between 15,000 g/mol and 70,000 g/mol approximately: these values are intermediate between 180 g/mol and 10⁶ g/mol, giving the name partially hydrolysed guar (English: PHGG, “partially hydrolysed guar gum”).

According to another embodiment, said guar gum is neutral in taste.

Within the scope of the invention a guar gum “neutral in taste” does not give a taste of bean, as does for example native guar gum. In addition, it does not give an acidic/sharp taste such as the taste of vinegar (this taste is leant by the chemical hydrolysis process of guar gum). In other terms, guar gum “neutral in taste” contributes no undesirable aftertaste.

To get interesting effects from the nutritional viewpoint, said guar gum is advantageously added up to 1 to 6 g approximately, preferably from 1.5 to 3 g approximately, preferably again at the rate of at least 2 grams approximately per portion of product ingested. The term “portion” here designates a packaging unit of the product in its commercial form. For example, this can be a pot of yoghurt, a bottle of drinkable yoghurt, a pot or a dish of fresh cheese.

For reasons of technical feasibility of the product according to the present invention, it is preferred to add guar gum, preferably at least partially hydrolysed, at the rate of 0.5 to 8 g approximately per 100 g of finished product, preferably at the rate of 1 to 3 g approximately per 100 g of finished product.

According to an embodiment, the milk product focussed on by the present invention further comprises other ingredients selected from stabilisers, sweeteners, aromas, taste exhausters, colourings, anti-foaming agents, fruits, etc.

Another aspect of the present invention concerns a manufacturing process for a fresh dairy product as described above.

According to an embodiment, such a process comprises at least:

a) addition to a milk mixture of one or more satietogenic ingredients comprising at least proteins such that the enrichment factor of the mixture in (or with) satietogenic proteins varies from 2 to 5 approximately, preferably from 3 to 5 approximately, with a particularly preferred value at 3 approximately, relative to the content of proteins in the initial mixture;

b) thermal treatment then homogenisation of the resulting mixture or, reciprocally, homogenisation then thermal treatment of the resulting mixture;

c) fermentation of the mixture coming from step b), resulting in its acidification;

d) cooling of the fermented mixture; and

e) optionally, the packaging of the resulting mixture.

The satietogenic proteins added at step a) preferably comprise seric proteins such that the enrichment factor of the mixture with seric satietogenic proteins varies from 2 to 5 approximately, preferably from 3 to 5 approximately, with a preferred value at 3 approximately, relative to the content of seric proteins in the initial mixture.

According to another embodiment, a manufacturing process according to the invention comprises at least:

a) thermal treatment then homogenisation of a milk mixture or, reciprocally, homogenisation then thermal treatment of a milk mixture;
b) fermentation of the mixture coming from step a), resulting in its acidification;
c) addition to the mixture coming from step b) of an intermediary food preparation containing one or more satietogenic ingredients comprising at least proteins such that the enrichment factor of the mixture with satietogenic proteins varies from 2 to 5 approximately, preferably from 3 to 5 approximately, with a preferred value at 3 approximately, relative to the protein content in the initial mixture;
d) cooling of the mixture resulting from step c); and
e) optionally, packaging of the resulting mixture.

The satietogenic proteins added at step c) preferably comprise seric proteins such that the enrichment factor of the mixture with seric satietogenic proteins varies from 2 to 5 approximately, preferably from 3 to 5 approximately, with a particularly preferred value at 3 approximately, relative to the content of seric proteins in the initial mixture.

It is possible, prior to step a) of thermal treatment/homogenisation, to add one or more satietogenic ingredients to said milk mixture.

In addition, a powdering step is preferably conducted prior to step a) of thermal treatment/homogenisation (standardisation of dry matter of the milk mixture).

Advantageously, the intermediary food preparation further comprises one or more pectins, and preferably at least one highly methylated pectin.

In particular, during its manufacture, the intermediary food preparation is advantageously subjected to thermal treatment at a temperature varying from 70 to 95° C. approximately, for a period varying from 1 to 5 minutes approximately. Said thermal treatment is preferably conducted at a temperature varying from 80 to 90° C. approximately, the temperature is preferably 85° C. approximately, for a period varying from 2 to 4 minutes approximately, preferably a period of 3 minutes approximately.

It will be interesting to limit the pH of the intermediary preparation to a range from 3 to 3.5 approximately, preferably from 3.15 to 3.35 approximately, preferably again the pH is 3.25. Lowering the pH advantageously reduces the amphoteric character of the proteins, which overall carry a greater net positive charge. In return, the electrostatic repulsion between the positively charged groups of proteins tends to limit aggregation of the latter and improves the homogeneity and texture of the preparation after thermal treatment (absence of grains, particles or filaments of coagulated proteins). A low pH value of around 3 is preferably fixed, essentially to avoid an overly acid taste of the intermediary preparation on the one hand and of the final product on the other hand. Acidification is preferably carried out conjointly to addition of highly methylated pectin, after thermal treatment resulting in a thoroughly homogeneous, smooth and unctuous intermediary preparation.

In the inventive processes thermal treatment can be conducted equally prior to homogenisation or, inversely, homogenisation prior to thermal treatment. These two sequential orders of steps are therefore reciprocated, alternative and equivalent.

The processes according to the invention preferably also comprise at least one smoothing step of the mixture, conducted prior to and/or after step d) of cooling of said mixture.

The processes according to the invention can utilise, during the acidification step, a ferment comprising at least the strain Streptococcus thermophilus 1-1477, filed with the CNCM (Institut Pasteur, Paris, France) on 22 Sep. 1994.

In order to get the best results in terms of (α) satietogenic power, (β) nutritional properties and (γ) properties of texture and viscosity of the product, and in terms of (δ) compatibility of the manufacturing process of the product with the technological and industrial constraints mentioned earlier (cf. points i) to (vii) and 1 to 3 above), the satietogenic proteins added to the milk mixture preferably comprise from 2 to 30% by weight approximately, preferably from 8 to 25% by weight approximately, more preferably again at least 16% by weight approximately, of particulate seric proteins, the rest (that is from 70 to 98% by weight approximately, preferably from 75 to 92% by weight approximately, more preferably again at a maximum 84% by weight approximately) being essentially made up of milk powder and/or caseins (for example, sodium caseinate) and/or seric proteins and/or vegetable proteins.

In the embodiments utilising by way of satietogenic ingredients not only proteins (especially seric proteins, preferably particulate) but also dietary fibre, especially guar gum, it is preferred to add (either directly to the milk mixture, or via an intermediary preparation) guar gum (in particular, at least partially hydrolysed guar gum) at the rate of 0.5 to 8 g approximately per 100 g of finished product, preferably at the rate of 1 to 3 g approximately per 100 g of finished product.

Interestingly, the conditions for using the satietogenic ingredients were selected by the inventors such that these ingredients contribute no quantity of lactose likely to inhibit fermentation. Therefore, the satietogenic ingredients are advantageously employed so as not to exceed 11 g approximately of lactose per 100 g of finished product.

To prevent unwanted deterioration during thermal treatment the satietogenic proteins are advantageously used such that the caseins/seric proteins ratio in the fermented milk mass varies from 2.0 to 4.88 approximately, preferably from 2.5 to 3.5 approximately and, even more preferably, from 2.8 to 3.3 approximately.

According to yet another aspect, the aim of the present invention is a manufacturing process for an intermediary food preparation useful for making a fresh dairy product comprising seric satietogenic proteins as described hereinabove, said process comprising at least:

a) addition of one or more satietogenic ingredients comprising seric proteins to an aqueous food preparation;
b) optionally, previous, concomitant or later addition of pectin to said preparation;
c) adjustment of the pH of the preparation to a target value, especially by addition of citric acid; and
d) thermal treatment of said preparation at a temperature varying from 70 to 95° C. approximately, for a period varying from 1 to 5 minutes approximately, so as to obtain an intermediary food preparation.

Advantageously, the thermal treatment step is conducted at a temperature varying from 80 to 90° C. approximately, preferably the temperature is 85° C. approximately, for a period from 2 to 4 minutes approximately, preferably a period of 3 minutes approximately, by maintaining pH from 3 to 3.5 approximately, preferably from 3.15 to 3.35 approximately, preferably again pH of 3.25 approximately.

The intermediary preparation will preferably be used such that the seric satietogenic proteins it contains represent at least 5% of the proteins of the finished product.

According to an advantageous embodiment, the satietogenic ingredients added to the aqueous food preparation during step a) comprise fibres, especially guar gum and, preferably, at least partially hydrolysed guar gum.

The present invention concerns, in another aspect, an intermediary food preparation obtainable by a process such as described above.

Yet another aspect of the invention relates to using the abovementioned intermediary food preparation to make a fresh dairy product having satietogenic power. Such a fresh dairy product advantageously conforms with the preceding description.

The abovementioned intermediary food preparation can be used to enrich a fresh dairy product in seric satietogenic proteins at the rate of an enrichment factor varying from 2 to 5 approximately, preferably varying from 3 to 5 approximately, with a particularly preferred value at 3 approximately, relative to the content of seric proteins in the initial product.

Advantageously, the inventive intermediary food preparation will be used to incorporate seric satietogenic proteins into the fresh dairy product such that they will represent at least 5% of the total proteins contained in the finished product.

Another aspect of the present invention relates to using one or more satietogenic ingredients comprising at least seric milk proteins, preferably particulate, and, where required, hydrosoluble fibres, preferably viscosifying hydrosoluble fibres, to prepare a fresh dairy product having satietogenic power.

According to a preferred embodiment, said fibres comprise guar gum, preferably at least partially hydrolysed guar gum.

The following figures illustrate examples of embodiments of the present invention:

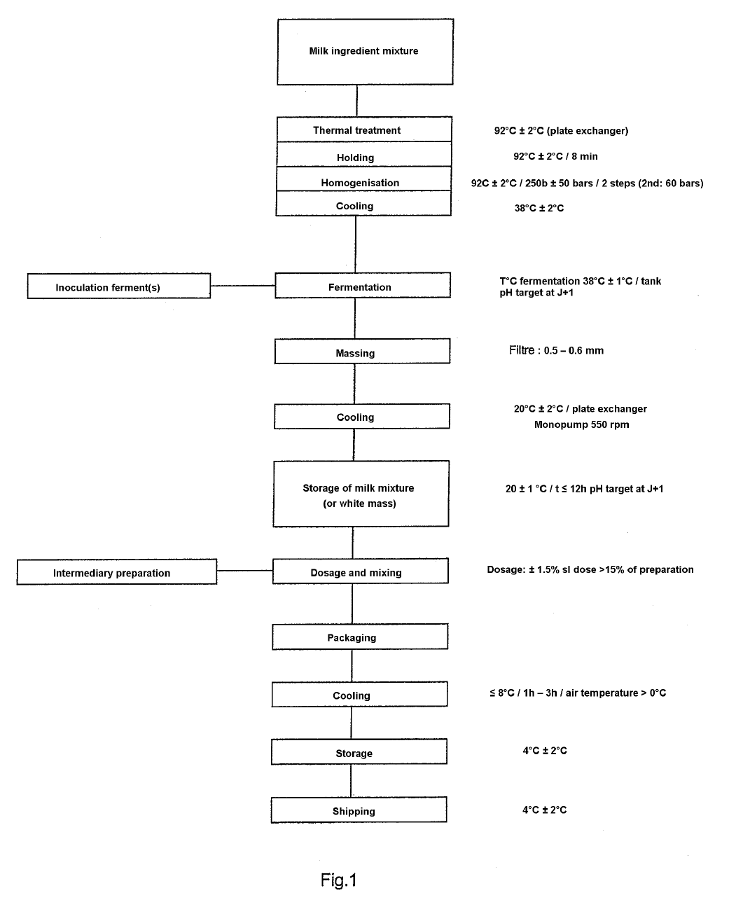

FIG. 1: diagram of a manufacturing process for a fresh dairy product of yoghurt type with food fruit and fibres, with 0% added sugar and without fats;

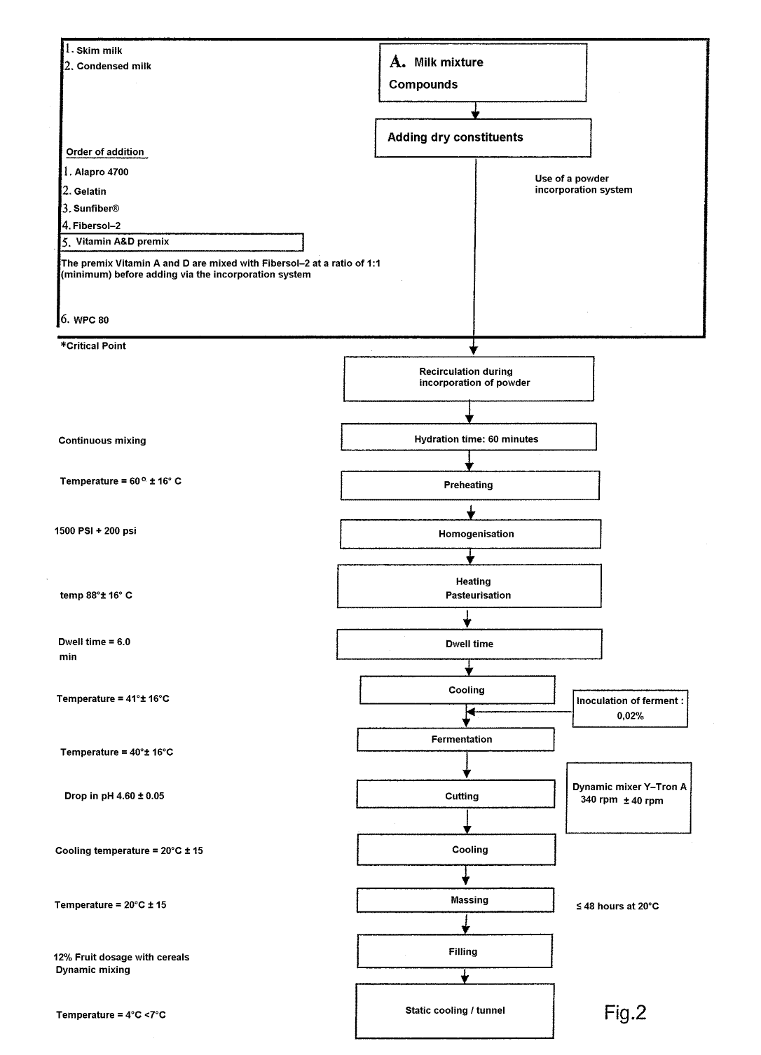

FIG. 2: diagram of a manufacturing process for a fresh dairy product of the yoghurt type with fruit containing dietary fibre, with 0% added sugar and without fats.

Other embodiments and advantages of the present invention will emerge from the following examples, intended to illustrate without limiting the invention.

### EXAMPLES

1. Yoghurt with Fruit Highly Enriched with Proteins and Containing Dietary Fibre

TABLE 2
Formula at 13% protein

| Composition in | | |
|---|---|---|
| mixture | | Ingredients |
| White mass | 85% | 13% protein |
| at 13% | | 10% lactose |
| protein | | 0.3% lipids |
| | | 76.7% water |
| Fruit | 15% | 25% apple purée (concentration × 1.6) |
| preparation | | 13% NZMP 8899 (12.1% protein - 0.2 fats) |
| at 13% | | 11% Sunfiber ® |
| protein | | 0.5% highly methylated pectin |
| | | 0.1% aspartame |
| | | 0.05% acesulfame K |
| | | 1.7% citric acid |
| | | 48.65% water |

with the following composition of the milk mixture (white mass):
skim milk 80.79%
milk powder skim (EPI Ingredients) 9.92%

### Simplesse 100 E (CP Kelco) 3.96%

Sodium caseinate (Armor Proteines) 5.32%
2, Yoghurt with Fruit and Dietary Fibre—0% Added Sugar and Fats

2.1. Examples of Final Yoghurt Formulas:

a) Skim milk, milk powder skim, apple (3.0%), milk protein concentrate, guar gum (alimentary fibre) 1.7%, cereals (1.5%) (oat bran and wheat bran), fructose (1.3%), soya proteins (1.2%), ferments, sweeteners (aspartame and acesulfame K) and aromas.

b) Skim milk, milk powder skim, fruits (1.4% fresh, 0.5% cherry, 0.5% strawberry and 0.2% redcurrant), milk protein concentrate, guar gum (alimentary fibre) 1.7%, cereals (1.5%) (oat bran and wheat bran), fructose (1.3%), soya proteins (1.2%), ferments, sweeteners (aspartame and acesulfame K) and aromas and natural colourings E-120.

2.2. Case of Formulation a) According to Paragraph 2.1

a) Per 100 g of finished product

TABLE 3

| | % weight |
|---|---|
| Skim milk 0.05% of MG* | 72.414 |
| Skim milk powder 1% MG | 5.492 |
| Concentrate of milk proteins 50% prot | 2.025 |
| Crystalline fructose | 1.053 |
| Acesulfame K | 0.009 |
| Preparation of apple fruit cereals | 19.000 |
| Ferments | 0.008 |

MG: Fats

b) Composition of an intermediary preparation

TABLE 4

| | Ingredients | Quantity (%) |
|---|---|---|
| Fruits | Apple | 16 |
| (vegetable/ | aseptic/in | |
| cereal) | frozen form | |
| | purée | |
| | size < 0.6 mm | |
| | Oats | 5 |
| | dehydrated | |
| | bran | |
| | 0.5 ≦ size ≦ 1.5 mm | |
| | Wheat | 3 |
| | dehydrated | |
| | bran | |
| | 0.5 ≦ size ≦ 1.5 mm | |
| Sugar and/or | Fructose | 1.3 |
| sweetener | Aspartame (E-951) | 0.087 |
| Other Ingredients | Water | |
| | dispersion | 53.183 |
| | Fibre | |
| | Sunfiber ® | 11 |
| | Soya | |
| | Soy protein | 8 |
| | Stabiliser | |
| | pectin | 0.90 |
| | guar gum | 0.30 |
| | pH Regulator | |
| | lactic acid | 0.20 |
| | Aroma | |
| | apple | 0.13 |

This intermediary preparation is formulated so as to obtain 2 g of guar gum per pot of 125 g of finished product.

c) Targeted characteristics of a finished product

TABLE 5

| | J + 1 |
|---|---|
| | Target +− |
| Parameters | Tolerance |
| Viscosity TA-XT2 | 28.0 +− 5.0 |
| PH | 4.40 +− 0.15 |

### (L) Legal

DLC: Best-by date

d) Parameters of a finished product

TABLE 6

| Analysis | Target | Tolerance |
|---|---|---|
| Dry matter (%) | 18.2 | 17.2-19.2 |
| Lipids (%) | 0.19 | 0.05-0.25 |
| Proteins (%) | 6.50 | 6.40-6.70 |

### (L) Legal.

The minimum rate of proteins in the product is preferably from 6 to 7% approximately, this rate being even more preferably 6.5% approximately.

e) Example of a manufacturing process

An example of a manufacturing process is illustrated in FIG. 1.

3. Fruit Yoghurt containing Dietary Fibre—0% Added Sugar and Fats

Guar gum is added directly to the milk mixture (or white mass), to obtain 2 g of guar gum per pot of 170 g. The finished product contains preferably between 6% and 7% approximately of total proteins.

3.1. Composition of a finished product

TABLE 7

| Ingredients | % |
|---|---|
| Standardised skim milk | 82.547 |
| Alapro 4700 | 1.265 |
| Gelatin, 250 bloom | 0.276 |
| Sunfiber ® | 1.500 |
| Fibersol-2 | 1.125 |
| WPC 80 | 1.265 |
| Vit A, D | 0.004 |
| Culture | 0.018 |
| Preparation of fruit and cereal | 12.000 |
| Total | 100 |

3.2. Example of a manufacturing process

An example of a manufacturing process is illustrated in FIG. 2.

4. Fresh Cheese Enriched with Proteins and Containing Dietary Fibre −0% Added Sugar and Fats

An intermediary preparation containing 5 to 6% approximately of already acidified seric milk proteins (Whey Protein lsolate NZMP 8899-NZMP, Rellingen, Germany) is added to a milk mixture of the fresh cheese type, containing already 8.6% approximately of proteins.

This intermediary preparation is formulated such that 2g of guar gum are added per pot of 150g of finished product.

The final product obtained contains preferably 7.5% approximately of total proteins.

5. Drinkable Yoghurt containing Dietary Fibre

The final product obtained contains preferably 4.5% of total proteins. The milk is enriched with proteins by incorporating a mixture of milk proteins in the form of powder (Promiik 602 (INGREDIA))

An intermediary preparation containing guar gum and, optionally fruits, is added to a milk mixture.

### REFERENCE

Anderson G H, et al. J Nutr. 2004, 134(4):974S-9S.
Araya H, et al. Eur J Clin Nutr 1999, 53(4): 273-6
Araya H, et al. lnt J Food Sci Nutr 2000, 51(2): 119-24
Bell E. et al. Am J Clin Nutr 1998, 67: 412-20
Bensaid A. et al. Physiol Behav 2002, 75: 577-82
Booth D A. Ann NY Acad Sci, 1985; 443: 22-41.
Burton-Freeman B. J Nutr 2000, 130: 2725-275S
Delargy H J et al. lnt J Food Sci Nutr 1997, 48(1): 67-77
De Graaf et al. Am J Clin Nutr 2004, 79:946-61
Green S M, et al. Appetite 1997, 29(3): 291-304
Green S M, et al. Br J Nutr 2000, 84(4): 521-30
Holt S H, et al. J Am Diet Assoc 2001, 101(7): 767-73
Howarth N C, et al. Nutr Rev 2001, 59(5): 129-39
Labouré H, et al. Am J Physiol Regui Integr Comp Physiol 2002, 282(5): 1501-1511
Louis-Sylvestre J, et al. Neurosci Biobehav Rev, 1980, 47: 608-628.
Mayer J. Glucostatic mechanism of regulation of food intake. N Engl J Med, 1953; 249: 13-16.
Melanson K J, et al. Am J Physiol, 1999; 277: R337-R345.
Marciani L1 et al. Am J Physiol Gastrointest Liver Physiol 2001, 280(6): G 1227-33
Mattes R D & Rothacker D. et al. Physiol Behav 2001, 74 (4-5): 551-7
Poppitt S D et al. Physiol Behav 1998, 64(3): 279-85
Rolls B J, et al. Am J Clin Nutr 1999, 70(4): 448-55
Rolls B J, et al. Am J Clin Nutr 2000, 72(2): 361-8
Warwick Z S, et al. Am J Physiol Regul Integr Comp Physol 2000, 278(1):
R196-200
Westerterp-Plantenga M S, et al. Eur J Clin Nutr 1999, 53(6): 495-5
G. Robinson, et al. Carbohydrate Research, 107, 17, 1982.
B. Launay, and al.: flow properties of aqueous solutions and dispersions of polysaccharides, Functional Properties of Food Macromolecules, Elsevier Applied Science Pubs, London, 1986.

1.-38. (canceled)

39. A method for manufacturing a fresh dairy product, comprising at least:
a) the addition of one or more satietogenic ingredients comprising at least proteins, said ingredients being selected from the group consisting of vegetable proteins, milk powder, casein, and seric proteins, wherein:
the enrichment factor in satietogenic proteins varies from 2 to 5 approximately relative to the content of proteins in the initial mixture; and
the fresh dairy product contains up to 11% approximately by weight of lactose per 100g;
b) thermal treatment then homogenization of the resulting mixture or, reciprocally, homogenisation then thermal treatment of the resulting mixture;
c) fermentation of the mixture resulting from step b), resulting in its acidification;
d) cooling of the fermented mixture resulting from step c); and
e) optionally, packaging of the resulting mixture.

40. The method as claimed in claim 39, wherein said satietogenic proteins added in step a) comprise seric proteins, wherein the enrichment factor of the mixture in seric satietogenic proteins varies from 2 to 5 approximately, relative to the content of seric proteins in the initial product.

41. The method as claimed in claim 40, wherein said seric proteins are particulate.

42. The method as claimed in claim 39, wherein said satietogenic proteins added to the milk mixture represent from 2 to 30% by weight approximately of particular seric proteins contained.

43. The method as claimed in claim 39, wherein said fresh dairy product is selected from the group consisting of yoghurts, drinkable yoghurts, fresh cheese, and fermented milks.

44. The method as claimed in claim 43, wherein the content of total proteins in said product is:
5 to 20% approximately for yoghurt;
3 to 20% approximately for drinkable yoghurt;
6 to 20% approximately for fresh cheese.

45. The method as claimed in claim 39, wherein said fresh dairy product further comprises one or more pectins.

46. The method as claimed in claim 45, wherein said one or more pectins comprises at least one highly methylated pectin.

47. The method as claimed in claim 39, wherein said fresh dairy product further comprises dietary fibers other than pectins.

48. The method as claimed in claim 47, wherein said fibers comprise fibers selected from the group consisting of non-hydrosoluble fibers of fruits and cereals, resistant starches and resistant maltodextrins, polydextrose, fructooligosaccharides, and mixtures thereof.

49. The method as claimed in claim 48, wherein said fibers comprise hydrosoluble satietogenic viscosifying fibers.

50. The method as claimed in claim 49, wherein said fibers are selected from the group consisting of galactomannanes, glucomannanes, carrageenans, alginates, psyllium, and combinations thereof.

51. The method as claimed in claim 50, wherein said fibers comprise at least guar gum.

52. The method as claimed in claim 51, wherein said guar gum is at least partially hydrolysed.

53. The method as claimed in claim 39, further comprising at least one smoothing step of the mixture, conducted prior to and/or after the cooling step d) of said mixture.

54. The method as claimed in claim 39, wherein the acidification step is conducted by means of ferment comprising at least the Streptococcus thermophilus 1-1477 strain, filed with the CNCM (Institut Pasteur, Paris, France) on Sep. 22, 1994.
